(19) United States
(12) Patent Application Publication
(10) Pub. No.: US 2026/0119372 A1
(43) Pub. Date: Apr. 30, 2026

(54) CONVERSATIONAL TEST DATA GENERATOR

(71) Applicant: SAP SE, Walldorf (DE)

(72) Inventor: Prashant TELKAR, Bangalore (IN)

(21) Appl. No.: 18/926,597

(22) Filed: Oct. 25, 2024

(51) Int. Cl. G06F 11/36; G06F 9/54; G06F 16/22; H04L 51/02

(52) U.S. Cl. CPC G06F 11/3668; G06F 9/54; G06F 16/2237; H04L 51/02

(57) ABSTRACT

A system and method include operation of a chatbot application to receive a first identifier of a data type, a second identifier of a data object, and a third identifier of a target system, generation of a first multi-dimensional vector based on the identifiers, searching of a vector database of multi-dimensional vectors to identify a second multi-dimensional vector similar to the first vector and a candidate data object instance corresponding to the second vector, prompting of a text generation model to output an indication of whether or not the candidate data object instance is usable in the target system, and, in response to an indication that the candidate data object instance is usable, calling of an application programming interface of the target database system to store the candidate data object instance in the target system.

### BACKGROUND

Modern enterprises generate and store vast amounts of data, generally categorized as master data and transaction data. Software applications allow users to review, manage and analyze the data to assist enterprise processes. Development and testing of such applications typically require sample master data and transaction data.

Master data is largely static and may describe entities such as customers, vendors, products, and other enterprise units. Master data is typically shared across processes and transactions, serving as a common resource for multiple facets of enterprise operations. Transaction data, in contrast, may represent activities and events carried out in the enterprise. Transaction data encompasses records of a wide range of transactions, including but not limited to sales orders, purchase orders, invoices, deliveries, and production orders. For example, a sales order may reference fields of a customer's master data, and a purchase order may reference fields of a vendor's master data.

Creating master data and transaction data which are adequate for testing is a complex, labor-intensive, and error-prone task. Traditional manual methods for generating such data lead to inconsistencies that compromise the integrity of testing. Current techniques rely on predefined rules and templates, which can limit the variability and complexity of the generated data and thereby fail to address the nuanced requirements of enterprise systems. For example, existing techniques do not integrate functional knowledge or modern Application Programming Interfaces (APIs) (e.g., OData).

What is needed are systems to efficiently generate high-quality sample master data and transaction data which facilitate application testing and development.

### BRIEF DESCRIPTION OF THE DRAWINGS

FIG. 1 illustrates a system to generate test data using a conversational interface according to some embodiments.

FIG. 2 is a flow diagram of a process to generate test data using a conversational interface according to some embodiments.

FIG. 3 illustrates populating a vector database according to some embodiments.

FIG. 4 is a representation of object metadata according to some embodiments.

FIG. 5 is a representation of a data template according to some embodiments.

FIG. 6 is a user interface of a chatbot application according to some embodiments.

FIG. 7 illustrates searching a vector database for test data based on input received by a chatbot application according to some embodiments.

FIG. 8 illustrates prompting of a text generation model according to some embodiments.

FIG. 9 is a user interface of a chatbot application according to some embodiments.

FIG. 10 is a diagram of a cloud-based implementation according to some embodiments.

### DETAILED DESCRIPTION

The following description is provided to enable any person in the art to make and use the described embodiments. Various modifications, however, will be readily-apparent to those in the art.

Embodiments may streamline the creation of high-quality test data for robust application testing. Some embodiments facilitate automatic generation of test data and direct injection of the test data into a target system, significantly reducing manual effort and minimizing human error. Embodiments may leverage a Retrieval-Augmented Generation (RAG) model trained on specific data of an enterprise to ensure the generated test data is contextually accurate and aligns with unique requirements of the enterprise. Embodiments further employ a text generation model to ensure functional and syntactic validity of the generated test data.

Briefly, in a specific example, a user interacts with a chatbot application to request generation of test data for a target system, such as a target database system. The chatbot application prompts the user to select a data type of the test data (e.g., master data or transaction data) and a data object of the data type (e.g., a Product, an Organization, a Sales Order, a Debit Memo).

A multi-dimensional vector is generated based on the data type and the data object. The multi-dimensional vector is used to search a vector database for one or more similar multi-dimensional vectors and text chunks corresponding to the similar multi-dimensional vectors. One or more candidate data object instances (e.g., JSON payloads) are generated based on the text chunks. A text generation model is then prompted to output an indication of whether or not the candidate data object instances are usable by the target system (e.g., whether the payloads conform to required structures and syntax). An application programming interface of the target system is called to store any candidate data object instances which are deemed usable in the target system.

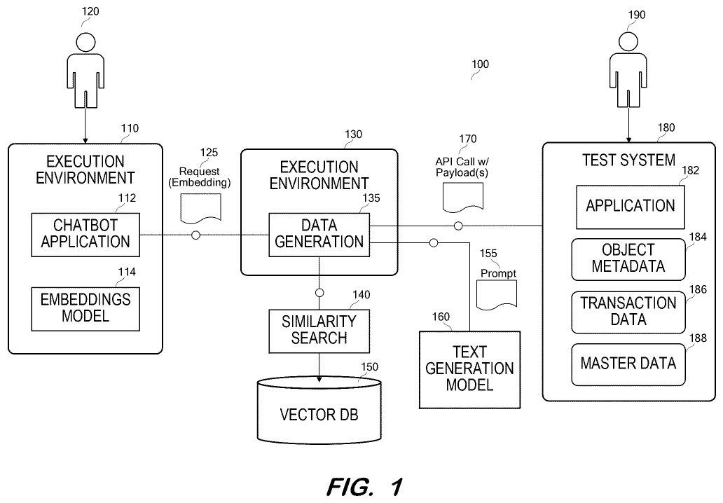

FIG. 1 illustrates an architecture to generate test data using a conversational interface according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric.

Execution environment 110 may comprise one or more servers, virtual machines, clusters of a container orchestration system, etc. Execution environment 110 may provide an operating system, services, I/O, storage, libraries, frameworks, etc. to applications executing therein. Chatbot application 112 and embeddings model 114 may comprise program code executable by execution environment 110 to operate as described herein. In some embodiments, embeddings model 114 is provided by a service external to and accessible by execution environment 110.

Chatbot application 112 may comprise a component of another application, such as an application which includes other functionality to facilitate application testing and/or development. User 120 may operate a user device (not shown) to access and interact with chatbot application 112. The user device may comprise, for example, a laptop computer, a desktop computer, a smartphone, or a tablet computer.

As described below, chatbot application 112 may operate to present user 120 with a series of simple queries to intuitively guide user 120 to provide information required to generate and deploy test data. Chatbot application 112 may prompt user 120 to specify a type of test data to be generated, an object of the type of test data to be generated, and a target system in which to deploy the test data. For example, if the type of test data is transaction data, chatbot application 112 receives an identifier of a specific transaction data object (e.g., a Sales Order object, a Production Order object) from user 120. In a case that the type of test data to be generated is master data, chatbot application 112 may prompt user 120 to specify a specific master data object (e.g., a Customer object, a Vendor object, a Material object, a Product object) and instance of the master data object (e.g., C123, V456, M789, P000) for which test data is to be generated.

Chatbot application 112 may transmit text received from user 120 to embeddings model 114. Embeddings model 114 is pre-trained to generate an embedding (i.e., a multi-dimensional numerical vector) intended to capture the semantic and syntactic meaning of input text. Embeddings model 114 may be implemented by executable program code, a set of hyperparameters defining a model structure and a set of corresponding weights, or any other representation of an input-to-output mapping.

Chatbot application 112 transmits request 125 to data generation component 135 of execution environment 135. In some embodiments, data generation component 135 may execute within execution environment 110. Request 125 includes one or more embeddings generated by model 114 and a request to generate test data based on the one or more embeddings.

Data generation component 135 calls similarity search component 140, which may comprise an API, to identify embeddings of vector database 150 which are similar to the embeddings of request 125. Vector database 150 stores embeddings in association with text data from which the embeddings were generated, and may comprise any implementation of a vector database that is or becomes known. The text data may comprise text chunks formed from object metadata, object instance data and synonymic name dictionaries as will be described below, with each embedding of vector database 150 having been generated from a respective text chunk. After identifying embeddings which are deemed similar to the embeddings received from data generation component 135, similarity search component 140 returns a text chunk associated with each of the similar embeddings.

Data generation component 135 generates one or more candidate object instances (i.e, JSON payloads) based on the returned text chunk(s). Prompt 155 may include the candidate object instances and instructions to determine whether candidate object instances are usable as test data in the target system. The instructions may include several steps to perform the determination, such as but not limited to verification that a candidate object instance includes all fields which are mandatory for the object of which the candidate is an instance, and verification that the data type and syntax of the value of each field conforms to the required data type and syntax.

Prompt 155 is transmitted to text generation model 160. Text generation model 160 may comprise a neural network trained to generate text based on input text. As noted with respect to embeddings model 114, text generation model 160 may be implemented by, for example, executable program code, a set of hyperparameters defining a model structure and a set of corresponding weights, or any other representation of an input-to-output mapping which was learned as a result of the training. According to some embodiments, model 160 is a Large Language Model (LLM) conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of text generation model 160 include GPT-4, LaMDA, Claude or the like. Model 160 may be publicly available or deployed within a landscape which is trusted by a provider of execution environment 110. Similarly, text generation model 160 may be trained based on public and/or private data.

Text generation model 160 returns an indication of whether or not each candidate object instance provided to model 160 is usable as test data in the target system. For each candidate object instance which is indicated as usable, data generation component 135 transmits API call 170 to store the candidate object instance in the target system specified by user 120 as described above. Embodiments may operate in conjunction with one or more user-specifiable target systems.

In the present example, test system 180 is a target database system specified by user 120. Test system 180 includes application 182 to be tested (or demonstrated, for example) and object metadata 184 describing the structure and interrelationships (i.e., the schema) of various master data objects and transaction data objects. Each data object includes a number of fields conforming to a hierarchical structure, each of which may be assigned one or more attributes. Transaction data 186 and master data 188 comprise instance data of specific instances of transaction data objects and master data objects, respectively. For example, transaction data 186 may include data of several different sales orders while master data 188 may include data of several different products.

The data of each instance may be stored in a corresponding row of a corresponding database table. Accordingly, in response to API call 170, test system 180 stores a candidate object instance corresponding to the payload of call 170 in appropriate database tables of transaction data 186 and master data 188. In one example, a sales order object instance may be stored in a sales_order database table of transaction data 186 and a product object instance may be stored in a product database table of master data 188.

User 190 may initiate testing or other operation of application 182. Testing may include any suitable testing protocols. Testing of application 182 may include reading, updating and deleting the stored candidate test data. The above process may be repeated to store new candidate test data in system 180 and to initiate further testing of application 182 based on the new candidate test data.

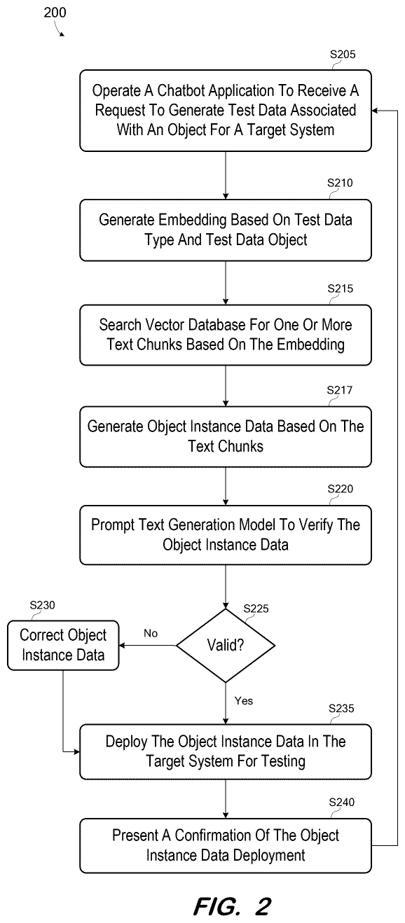

FIG. 2 comprises a flow diagram of process 200 to generate test data using a conversational interface according to some embodiments. Process 200 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

A vector database is populated prior to process 200. The vector database may be populated by the same entity which executes process 200 or by a different entity.

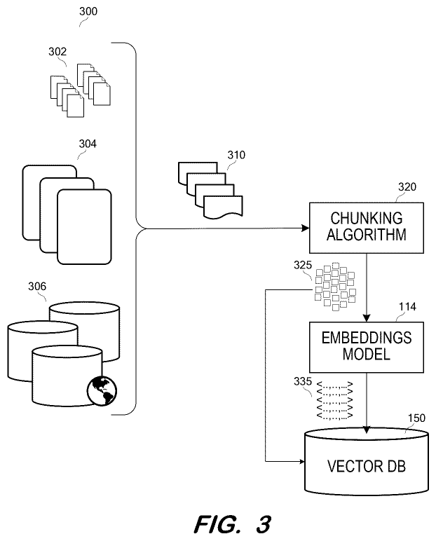

FIG. 3 illustrates populating vector database 150 according to some embodiments. Text sources 300 provide text 310 for populating vector database 150. Text 310 includes object metadata, object instance data, synonymic name dictionaries and any other text which may assist in generating test data as described herein. Text sources 300 from which text 310 is received may include, but are not limited to, documents 302, applications 304 and database systems 306.

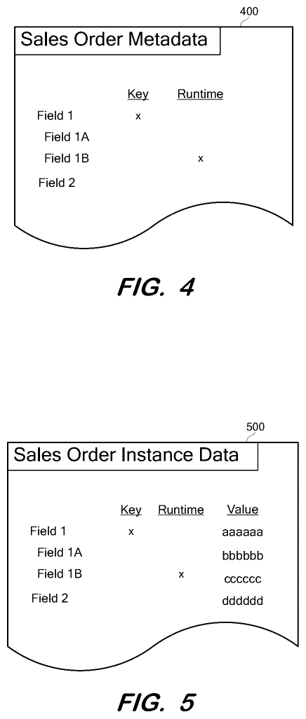

FIG. 4 is a representation of object metadata 400 of a sales order object according to some embodiments. Object metadata 400 defines four fields and associates attributes with several of the defined fields. For example, Field 1 is defined as a key field and Field 1B is defined as a Runtime field. FIG. 5 illustrates instance data 500 according to some embodiments. Instance data 500 includes object metadata 400 as well as values for each of the fields of object metadata 400. According to some embodiments, text 310 includes instance data 500 and object metadata 400 in a machine-readable format, such as a JavaScript Object Notation file.

A synonymic name dictionary may include enterprise-specific synonyms of commonly-used instance field values. The text of a synonymic name dictionary may be useful to a text generation model when determining the validity of a generated data instance.

Text data 310 may be combined into a single document prior to input to chunking algorithm 320. Chunking algorithm 320 may comprise any algorithm for generating text chunks 325 from text data 310 that is or becomes known. Chunking algorithm 320 may comprise, but is not limited to, a semantic chunking algorithm which divides text data 310 according to semantic boundaries. A chunk 325 may comprise complete instance data of an object.

Initially, chunking algorithm 320 may convert text data 310 into tokens consisting of words, subwords, or characters. A chunk size is then determined based on the token limit of a text generation model to be used. Chunks 325 may be formed by splitting text data 310 at natural breakpoints such as sentences, paragraphs or attributes. Some of chucks 325 may include the same (i.e., overlapping) tokens. For example, if the determined chunk size is 100 tokens, the next chunk may begin at token 80 of a prior chunk in order to preserve context between consecutive chunks.

Embeddings model 114 generates an embedding based on each of chunks 325, resulting in embeddings 335. Each of embeddings 335 is stored in vector database 150 in association with the chunk 325 from which it was generated. As a result, identification of an embedding 335 in vector database 150 allows retrieval of the chunk 325 used to generate the embedding 335.

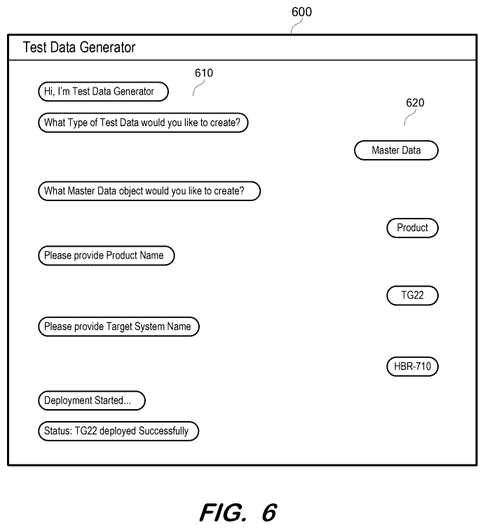

Returning to process 200, a chatbot application is operated at S205 to receive a request to generate test data associated with an object and for a target system. FIG. 6 illustrates user interface 600 of a chatbot application such as application 112 of FIG. 1. User 120 may access interface 600 via a Web browser and/or via a link provided by another application such as a launchpad. According to the present example, the chatbot application is intended to generate test data, and therefore the user access of the chatbot application is assumed to be a request to generate test data.

Chatbot text 610 includes text generated by the chatbot application. The chatbot application initially asks the user to specify the type of test data to be generated. As shown in user text 620, the user has indicated that master data is to be generated. Next, the chatbot application asks the user for the master data object to be represented by the generated test data and the user responds with an identifier (i.e., Product) of a product object. In some embodiments, each question of chatbot text 610 may be followed by selectable icons from which the user chooses to answer the question. For example, the question “What type of Test Data would you like to create?” may have been followed by icons indicating “Master Data” and “Transaction Data” respectively, and the question “What Master Data object would you like to create?” may have been followed by selectable icons respectively associated with Master Data objects of which test data can be generated.

Because the user has specified a master data object, chatbot text 610 also asks for an identifier of an instance of the specified master data object. In the present example, the user has entered “TG22” as an identifier of a product object instance. In response to receipt of the instance identifier, the chatbot application requests an identifier of a target system to which the test data is to be deployed. User text 620 shows target system identifier “HBR-710” as the user response

An embedding is generated at S210 based on the specified test data type (i.e., Master Data) and test data object (i.e., Product). According to the current example, the embedding is also generated based on the test data object instance (i.e., TG22). Generation of an embedding at S210 may include transmitting the text “Master Data Product TG22” to embeddings model 114 and receiving an embedding in return.

At S215, a vector database is searched for object instance data based on the embedding. First, stored embeddings which are similar to the embedding generated at S210 are identified using any suitable vector similarity metric. Next, the chunks associated with the similar embeddings are retrieved from the vector database and returned.

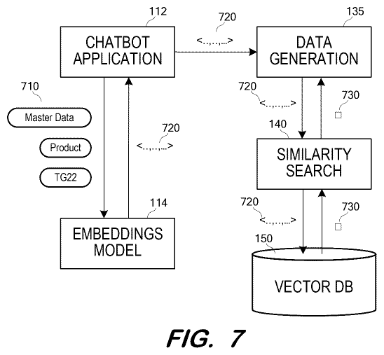

FIG. 7 illustrates searching a vector database based on input received by a chatbot application according to some embodiments. As described above, chatbot application 112 provides text 710 to embeddings model 114 and receives embedding 720 in return. Chatbot application 112 provides embedding 720 to data generation component 135, which calls similarity search component 140 to search vector database 150 based on embedding 720. Vector database 150 identifies chunk 730 which corresponds to a stored embedding which is most similar to embedding 720. Chunk 730 is then returned to data generation component 135.

Data generation component 135 creates a JSON structure of an object instance (i.e., a JSON payload) based on retrieved chunk 730. Component 135 may retrieve other chunks from vector database 150 at S215 to generate requested object instance data. For example, using the embedding generated at S210, data generation component 135 may retrieve chunks including portions of synonymic dictionaries and object metadata from vector database 150 and use the dictionaries and/or metadata to generate JSON payloads of one or more object instances.

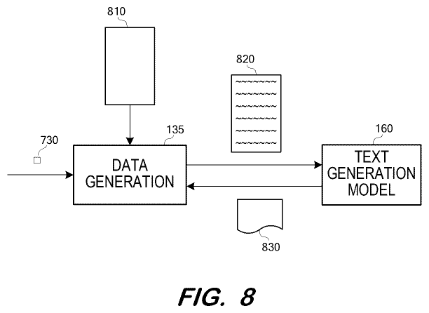

Next, at S220, a text generation model is prompted to verify the JSON payloads. S220 may comprise generating a prompt and transmitting the prompt to the text generation model. FIG. 8 illustrates prompting of a text generation model according to some embodiments.

Data generation component 135 receives chunk 730 as described above. Data generation component 135 generates a JSON payload based on chunk 730, uses prompt template 810 to generate prompt 820 and transmits prompt 820 to text generation model 160. According to some embodiments, data generation component 135 populates prompt template 810 with the JSON payload, metadata of the object represented by the payload, and an OData API structure to generate prompt 820. In some embodiments, prompt template 810 is transmitted to text generation model 160 as a system prompt and the JSON payload, object metadata, and the OData API structure are transmitted to text generation model 160 as a user prompt.

Prompt template 810 according to some embodiments may include the following, formatted as a system prompt:

“As an expert in cloud database systems and handling cloud OData APIs, you will be provided with metadata of an object, a JSON structure of an instance object and an OData API structure. Your task is to:
1. Parse the JSON structure: Break down the JSON structure to identify each key-field pair.
2. Verify Mandatory Fields: Check if all mandatory fields needed for creation of the mentioned object instance in a database system are present and meet the specified requirements (e.g., type, maxLength).
3. Assess Optional Fields: Verify that optional fields, if provided, comply with their respective constraints.
4. Identify Issues: List any missing or incorrect mandatory fields ONLY.
5. Provide a Response: Respond with ‘YES’ if the JSON structure is valid, or ‘NO’ followed by a comma-separated list of the problematic or missing fields.

Refer to the following example JSON structure for the ‘Product (Create)’ Object:

```
{
  “Product”: {
    “type”: “string”,
    “maxLength”: 40,
    “title”: “Product”
  },
  “ProductType”: {
    “type”: “string”,
    “nullable”: true,
    “maxLength”: 4,
    “title”: “Product Type”,
    “x-sap-object-node-type-reference”: “ProductType”
  },
  “CrossPlantStatus”: {
    “type”: “string”,
    “nullable”: true,
    “maxLength”: 2,
    “title”: “CrossPlantProdStatus”,
    “x-sap-object-node-type-reference”: “ProductProfileCode”
  },
  “CrossPlantStatusValidityDate”: {
    “type”: “string”,
    “nullable”: true,
    “example”: “/Date(1492041600000)/”,
    “title”: “Valid from”,
    “description”: “Date from which the cross-plant material
    status is valid”
  }
}
```

Based on the information provided, verify the input JSON structure and respond accordingly.”

In response to the prompt, model 160 returns indicator 830 indicating whether each candidate object instance is “valid” and therefore usable in the target system (e.g., ‘YES’) or “invalid” (e.g., ‘NO’). As shown in the example prompt above, an “invalid” indicator may be followed by a comma-separated list of problematic or missing fields.

If an indicator returned by model 160 indicates that a candidate object instance data is valid, flow proceeds from S225 to S235 to deploy the object instance data in the target system for testing. If an indicator returned by model 160 indicates that candidate object instance data is invalid, flow proceeds from S225 to S230 to correct the candidate object instance data. The data may be corrected based on the list of problematic or missing fields following the indicator. Component 135 may correct the object instance data at S230 by retrieving related text chunks from vector database 150 and correcting the object instance data based thereon, by prompting model 160 to correct the object instance data (using the retrieved related text chunks or not), or otherwise. Flow then proceeds to S235 to deploy the corrected object instance data in the target system for testing. As described above, deployment may consist of calling an OData API of the target system to store the generated object instance data in a suitable data structure thereof.

A confirmation of deployment of the object instance data is presented at S240. Returning to FIG. 6, chatbot text 610 includes a message “Status: TG22 deployed Successfully” which confirms deployment of the generated object instance data. Embodiments of S240 are not limited to the foregoing example.

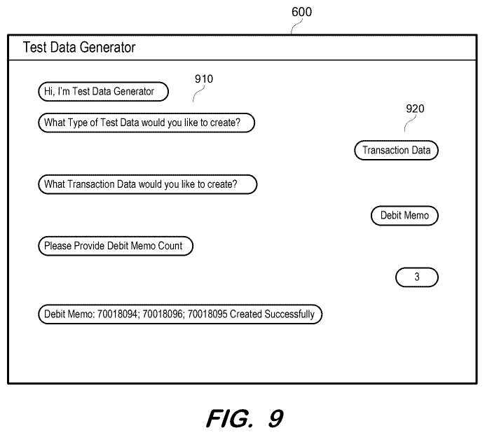

FIG. 9 is a user interface of a chatbot application according to some embodiments. As shown by user text 920, a user has specified the Transaction Data type of test data and a Debit Memo object. In contrast to the Master Data type of test data, the user need not specify a particular object instance of the Debit Memo object. Rather, user text 920 specifies a number of Debit Memo object instances to be created (i.e., 3).

Returning to process 200, an embedding is created at S210 based on the specified Transaction Data type and Debit Memo object. Next, at S215, a vector database is searched for the three most-similar embeddings and their corresponding object instance data. A text generation model is then prompted at S220 to verify the validity of all three sets of object instance data prior to deploying the three sets of object instance data to the target system at S235. A confirmation of the deployment is presented at S240, as shown in FIG. 9 (i.e., “Debit Memo: 70018094; 70018096; 70018095 Created Successfully”).

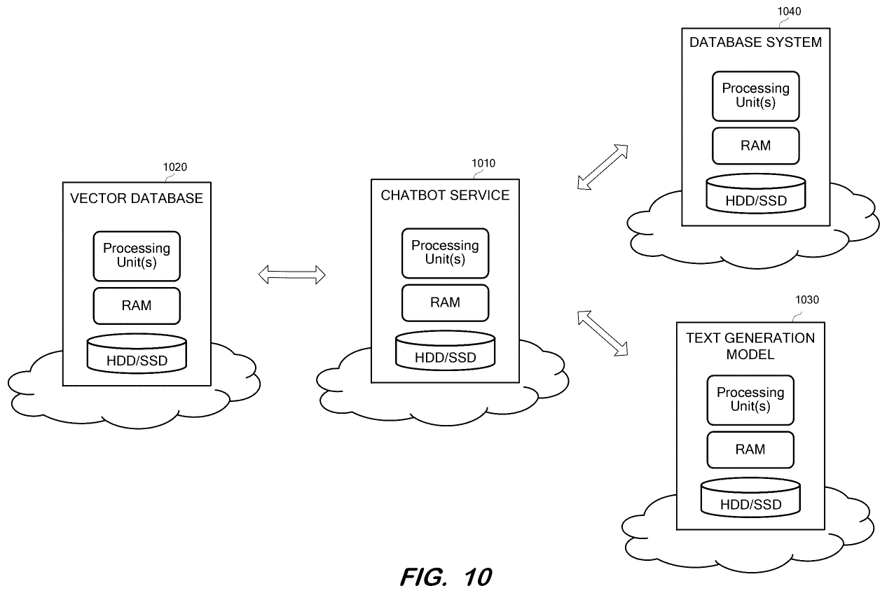

FIG. 10 is a diagram of a cloud-based implementation according to some embodiments. Chatbot service 1010 may provide chatbot functionality to a user and generate embeddings as described herein. Vector database 1020 may store embeddings and associated chunks of text data. Text generation model 1030 may be prompted to determine the validity of object instance data determined based on text chunks retrieved from vector database 1020 by chatbot service 1010. Finally, chatbot service 1010 may deploy validated object instance data to database system 1040 using an API provided by database system 1040.

Each of systems 1010 through 1040 may comprise cloud-based resources residing in one or more public clouds providing self-service and immediate provisioning, autoscaling, security, compliance and identity management features. Each of systems 1010 through 1040 may comprise servers or virtual machines of respective Kubernetes clusters, but embodiments are not limited thereto.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing program code; and
at least one processing unit to execute the program code to cause the system to:
operate a chatbot application to receive from a user a first identifier of a data type, a second identifier of a data object, a third identifier of a target system;
generate a first embedding based on the first identifier, second identifier and third identifier;
search a vector database of embeddings to identify a second embedding similar to the first embedding and a first text chunk corresponding to the second embedding;
generate a candidate data object instance based on the first text chunk;
prompt a text generation model to output an indication of whether or not the candidate data object instance is usable;
receive an indication from the text generation model that the candidate data object instance is usable; and
in response to the indication that the candidate data object instance is usable, call an application programming interface of the target system to store the candidate data object instance in the target system.

2. The system of claim 1,
wherein the data type is master data,
wherein the chatbot application is operated to receive a fourth identifier of an instance of the data object, and
wherein the first embedding is generated based on the first identifier, second identifier, third identifier and fourth identifier.

3. The system of claim 1, the at least one processing unit to execute the program code to cause the system to:
acquire metadata of a plurality of objects;
acquire instance data of each of the plurality of objects;
generate a plurality of text chunks from the metadata and instance data;
generate an embedding from each of the plurality of text chunks; and
store each embedding in the vector database in association with the text chunk from which the embedding was generated.

4. The system of claim 3, the at least one processing unit to execute the program code to cause the system to:
acquire a synonymic dictionary of master data,
wherein the plurality of text chunks are generated from the metadata, the instance data, and the synonymic dictionary.

5. The system of claim 1, wherein prompting of the text generation model comprises generation of a prompt including an instruction to verify whether the candidate data object instance includes values corresponding to all mandatory fields and whether the values conform to requirements of their corresponding mandatory fields.

6. The system of claim 1,
wherein searching of the vector database comprises searching of the vector database to identify a third embedding similar to the first embedding and a second text chunk corresponding to the third embedding, and
wherein the candidate data object instance is generated based on the first text chunk and the second text chunk.

7. The system of claim 1, the at least one processing unit to execute the program code to cause the system to:
generate a second candidate data object instance based on the first text chunk,
wherein prompting of the text generation model comprises prompting of the text generation model to output a second indication of whether or not the second candidate data object instance is usable, and
wherein the indication indicates that the candidate data object instance is usable and the second candidate data object instance is not usable.

8. A method comprising:
receiving, at a chatbot application, a first identifier of a data type, a second identifier of a data object, and a third identifier of a target database system;
generating a first multi-dimensional vector based on the first identifier, second identifier and third identifier;
searching a vector database of multi-dimensional vectors to identify a second multi-dimensional vector similar to the first multi-dimensional vector and a first text chunk corresponding to the second multi-dimensional vector;
generating a candidate data object instance based on the first text chunk;
prompting a text generation model to output an indication of whether or not the candidate data object instance is usable in the target database system;
receiving an indication from the text generation model that the candidate data object instance is usable in the target database system; and
in response to the indication that the candidate data object instance is usable in the target database system, calling an application programming interface of the target database system to store the candidate data object instance in the target database system.

9. The method of claim 8,
wherein the data type is master data,
wherein a fourth identifier of an instance of the data object is received at the chatbot application, and
wherein the first multi-dimensional vector is generated based on the first identifier, second identifier, third identifier and fourth identifier.

10. The method of claim 8, further comprising:
acquiring metadata of a plurality of objects;
acquiring instance data of each of the plurality of objects;
generating a plurality of text chunks from the metadata and instance data;
generating a multi-dimensional vector from each of the plurality of text chunks; and
storing each multi-dimensional vector in the vector database in association with the text chunk from which the multi-dimensional vector was generated.

11. The method of claim 10, further comprising:
acquiring a synonymic dictionary of master data,
wherein the plurality of text chunks are generated from the metadata, the instance data, and the synonymic dictionary.

12. The method of claim 8, wherein prompting the text generation model comprises generating a prompt including an instruction to verify whether the candidate data object instance includes values corresponding to all mandatory fields of the data object and whether the values conform to requirements of their corresponding mandatory fields.

13. The method of claim 8,
wherein searching the vector database comprises searching of the vector database to identify a third embedding similar to the first embedding and a second text chunk corresponding to the third embedding, and
wherein the candidate data object instance is generated based on the first text chunk and the second text chunk.

14. The method of claim 8, further comprising:
generating a second candidate data object instance based on the first text chunk,
wherein prompting the text generation model comprises prompting of the text generation model to output a second indication of whether or not the second candidate data object instance is usable in the target database system; and
wherein the indication indicates that the candidate data object instance is usable in the target database system and the second candidate data object instance is not usable in the target database system.

15. One or more non-transitory computer-readable recording media storing program code, the program code executable by at least one processing unit of a computing system to:
operate at a chatbot application to prompt a user to input a first identifier of a data type, a second identifier of a data object, and a third identifier of a target database system;
generate a first multi-dimensional vector based on the first identifier, second identifier and third identifier;
search a vector database of multi-dimensional vectors to identify a second multi-dimensional vector similar to the first multi-dimensional vector and a first text chunk corresponding to the second multi-dimensional vector;
generate a candidate data object instance based on the first text chunk;
prompt a text generation model to output an indication of whether or not the candidate data object instance is usable in the target database system;
receive an indication from the text generation model that the candidate data object instance is usable in the target database system; and
in response to the indication that the candidate data object instance is usable in the target database system, call an application programming interface of the target database system to store the candidate data object instance in the target database system.

16. The one or more non-transitory computer-readable recording media of claim 15, wherein the data type is master data,
wherein a fourth identifier of an instance of the data object is received at the chatbot application, and
wherein the first multi-dimensional vector is generated based on the first identifier, second identifier, third identifier and fourth identifier.

17. The one or more non-transitory computer-readable recording media of claim 15, the program code executable by at least one processing unit of a computing system to:
acquire metadata of a plurality of objects;
acquire instance data of each of the plurality of objects;
generate a plurality of text chunks from the metadata and instance data;
generate a multi-dimensional vector from each of the plurality of text chunks; and
store each multi-dimensional vector in the vector database in association with the text chunk from which the multi-dimensional vector was generated.

18. The one or more non-transitory computer-readable recording media of claim 17, the program code executable by at least one processing unit of a computing system to:
acquire a synonymic dictionary of master data,
wherein the plurality of text chunks are generated from the metadata, the instance data, and the synonymic dictionary.

19. The one or more non-transitory computer-readable recording media of claim 15, wherein prompting of the text generation model comprises generation of a prompt including an instruction to verify whether the candidate data object instance includes values corresponding to all mandatory fields of the data object and whether the values conform to requirements of their corresponding mandatory fields.

20. The one or more non-transitory computer-readable recording media of claim 15, the program code executable by at least one processing unit of a computing system to:
generate a second candidate data object instance based on the first text chunk,
wherein searching of the vector database comprises searching of the vector database to identify a third multi-dimensional vector similar to the first multi-dimensional vector and a second candidate data object instance corresponding to the third multi-dimensional vector, and
wherein prompting of the text generation model comprises prompting of the text generation model to output a second indication of whether or not the second candidate data object instance is usable in the target database system.
